(19) United States
(12) Patent Application Publication
(10) Pub. No.: US 2007/0282816 A1
(43) Pub. Date: Dec. 6, 2007

(54) Method and structure for string partial search

(76) Inventor: Shing-Jung Tsai, Bellevue, WA (US)

Correspondence Address: BIRCH STEWART KOLASCH & BIRCH, PO BOX 747, FALLS CHURCH, VA, 22040-0747, US

(21) Appl. No.: 11/806,795

(22) Filed: Jun. 4, 2007

Related U.S. Application Data
(60) Provisional application No. 60/811,226, filed on Jun. 5, 2006.

(51) Int. Cl. G06F 17/30

(52) U.S. Cl. 707/3

(57) ABSTRACT

An index structure, tendency B trees, to alleviate the high cost of string partial search in large data sets is presented. A tendency B tree is a two layered data structure, including a logical layer and a physical layer. In the logical layer, a tendency tree provides a hierarchical structure to group similar tendency features together to facilitate fast partial search for a given query. The physical layer is a B-tree like structure. In addition, the balanced topology of B trees provides consistent I/O complexity. The tendency B tree is dynamically compressed during the construction process to reduce storage and enhance search efficiency. Experiments on both dictionary search and DNA sequence search using tendency B trees show that consistent, fast search times can be achieved in large data sets, requiring lower space usage and linear construction time.

### BACKGROUND OF THE INVENTION

1. Field of the Invention

The present invention generally relates to a method and structure for string partial search, and more particularly to a method and structure for string partial search used to achieve fast search time, lower space usage and linear construction time.

2. Description of the Prior Art

DNA (random amplified polymorphic) sequence search is an extreme case of string search because of its small alphabet size and an enormous string length. In order to handle string partial search in DNAs, much effort has been made in recent years. Various data structures, such as the suffix tree, suffix array, level-compressed Patricia tree, string B tree, multi-dimensional index and suffix binary search tree, etc., have been introduced. In particular, extensive studies and improvements have been made which encompass data structures, construction algorithms, space usage, etc. The growing size of a DNA sequence makes this problem increasingly harder. Due to its fast growing rate, a solution that utilizes external-memory becomes essential. A few approaches fit in this category have been successful and have been successful in dealing with DNA sequence of size over 60 million base pairs (Mbp).

In suffix trees, the search time to find the first match-point of query string P with length p is O(p) in the worst-case. The O( ) is a big O expression and used to analysis the performance of the algorithm for the person having ordinary skill in the art. This worst-case search complexity is bounded by the query string length because of the unbalanced topology in suffix trees.

The string B-tree claims to be able to manage strings with unbounded length. Theoretically, it takes O(log_{B} n+p/B) disk accesses to reach the first match-point and is able to compete with the suffix tree where B is the B tree block size. A string B-tree places compact Patricia tries in the B-tree structure. Strings are stored as logical pointers to manage unbounded length strings. However, maintaining Patricia tries in each B-tree block is CPU intensive. Although only logical pointers are stored in page block, each logical pointer needs auxiliary pointers to maintain internal tree structure. In our knowledge, no large-scale DNA sequence set handled by string B-tree has be reported.

Therefore, there is a need to propose a new data structure used an external-memory approach and can be dynamically built in linear time. In this new data structure, the experiment results demonstrate that very efficient search time, reduced space usage and linear construction time can be achieved in large-scale data sets.

### SUMMARY OF THE INVENTION

One purpose of the present invention is to develop a database structure for string partial search.

Another purpose of the present invention is to develop a database structure for improving the I/O efficiency.

The other purpose of the present invention is to a database structure for reducing storage and enhancing search efficiency.

A data structure for string partial search is disclosed in the present invention. The data structure is a two layered data structure which contains a logical layer and a physical layer. In the logical layer, a trie, called the tendency tree, is used to group data items together by their tendency features to facilitate the substring search. By transforming the tendency tree into a one-dimensional tendency sequence set, a tendency tree is able to be stored into a B-tree like structure in the physical layer to take advantages of B tree characteristics. With additional analyses of the tendency sequence set, a compressed sequence set is proposed, which further reduces the storage requirements. A search algorithm has been developed to traverse the compressed sequence set, where a revelation key is dynamically obtained to reveal any missing information. At this point, the concept of a tendency tree transformed into a one-dimensional sequence set is realized.

In a tendency B tree, tendency features are represented by fixed-length tendency keys and a tendency tree is converted into a compressed sequence set. Thus, a linear space complexity O(n) can be guaranteed. In addition, the compressed sequence set provides us a way to solve the challenge of separator length in the B-tree like structures. Whenever splitting of a block is needed, a simple neighborhood search is invoked to find an appropriate-length separator from the compressed tendency sequence set. Such a neighborhood search incurs very little data skew. With p/B disk accesses, the proposed revelation key is able to restore the missing information of the nodes removed during the compression. The most important thing is that although the tendency tree is an unbalanced tree, the search complexity, O(log_{B} n+p/B), of finding the first matching point in tendency B tree is not dominated by the height of the tendency tree but is determined by the height of the B-tree like structure.

### BRIEF DESCRIPTION OF THE DRAWINGS

FIG. 1a is a table showing tendency feature of the present invention.

FIG. 1b is a table showing the tendency key of the present invention.

FIG. 1c is a table showing the tendency feature and the start position of the present invention.

FIG. 1d is a table showing the expended tendency feature and the origin of the present invention.

FIG. 1e is a table showing an example of the left-right comparison of the present invention.

FIG. 2 is a block diagram showing a tendency tree of the present invention.

FIG. 3 is a block diagram showing a collision detected in the present invention.

FIG. 4 is a block diagram showing the collision stopped in the present invention.

FIG. 5 is a block diagram showing the separator blocks and the leaf blocks in the present invention.

FIG. 6 is an algorithm of a source code showing the target node is found for a given query string in a leaf block.

FIG. 7 is a block diagram showing the compressed sequence set of the present invention.

FIG. 8 is a block diagram showing the domain integrity of the present invention.

FIG. 9a-FIG. 9c are flowchart showing the steps of the method for string partial search.

FIG. 10 is view showing the format of leaf blocks and tendency keys.

FIG. 11a-FIG. 11e are views showing the experiment result of the present invention.

### DETAILED DESCRIPTION OF THE PREFERRED EMBODIMENT

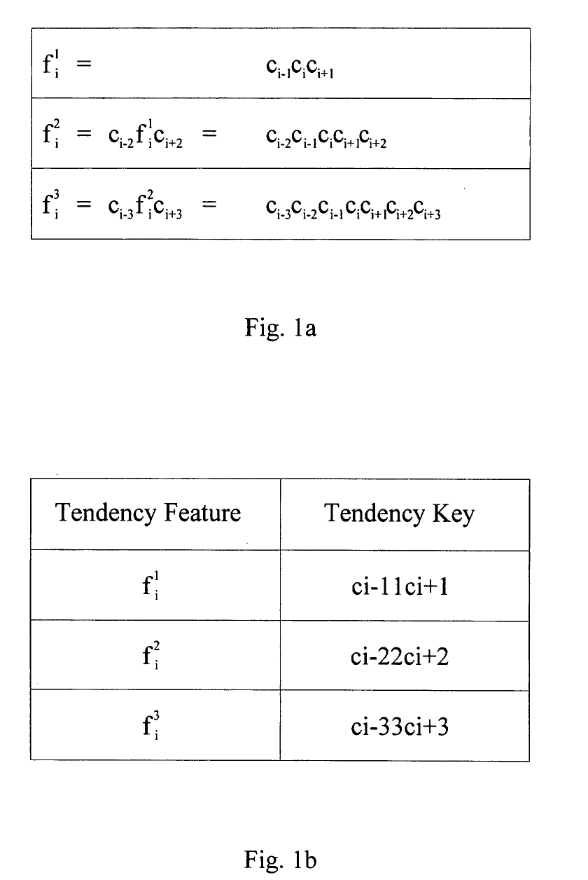

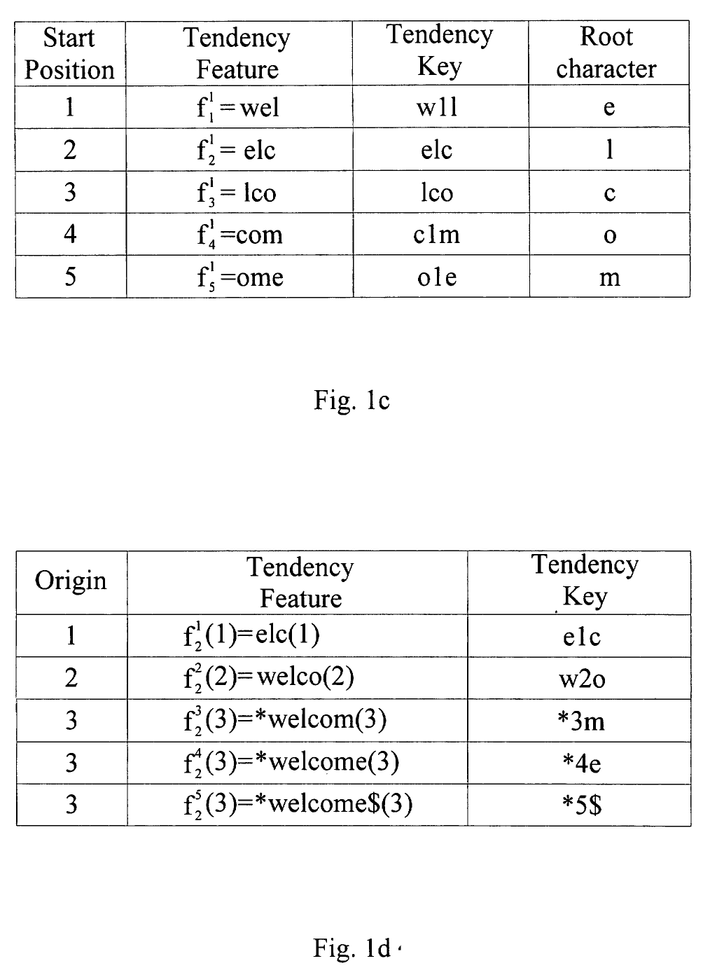

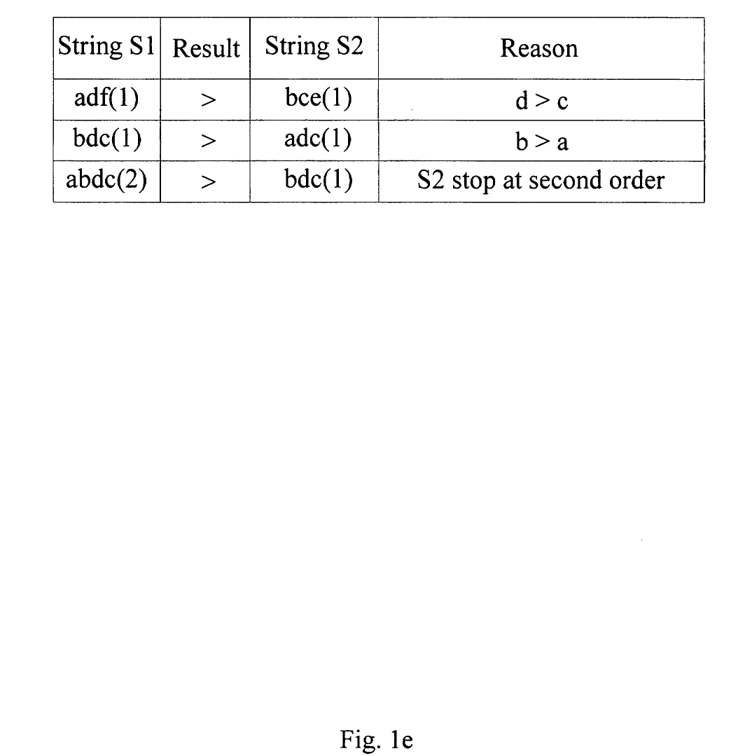

A structure for string partial search is disclosed in the present invention. This invention may be utilized in all kinds of computer based application, software, and data processing, also included data search via internet, intranet, or other kinds of data passage. FIG. 1a is a table showing tendency feature of the present invention. 5A string S=c₀c₁ . . . cₙ₋₁ of length n consists of characters from a finite character set Σ of size |Σ|. Each character cᵢ in S has two base tendencies, Backward Tendency cᵢ−1 and Forward Tendency cᵢ+1, where 1≦i≦n-2. The character cᵢ is referred to as a root character. Taking the root character cᵢ, a Tendency Feature fᵢ¹ can be composed around cᵢ as fᵢ¹=cᵢ₋₁cᵢcᵢ₊₁ in which the backward tendency cᵢ₋₁ and the forward tendency cᵢ₊₁ are added around cᵢ. For any tendency feature fᵢ¹, the index i denotes the tendency feature starting position in S and 1 indicates that fᵢ¹ is a base tendency feature or a first-order tendency feature. Every fᵢ¹ has length of |fᵢ¹|=3, and there are n-2 base tendency feature in S: f₁¹, f₂¹ . . . fₙ₋₂¹. Likewise, a base tendency feature fᵢ¹ can be further expanded by continuing to add its backward tendency and forward tendency. As the tendency feature expands, the order of the tendency feature increases. Let fᵢ^{j} be an expanded tendency feature where j is the tendency order, it can be equivalently represented as: fᵢ^{j}=cᵢ₋ⱼfᵢ^{j-1}cᵢ₊ⱼ=cᵢ₋ⱼcᵢ₋ⱼ₊₁fᵢ^{j-2}cᵢ₊ⱼ₋₁cᵢ₊ⱼ= . . . =cᵢ₋ⱼ . . . cᵢ₋₁ cᵢcᵢ₊₁ . . . cᵢ₊ⱼ.

The expanding of fᵢ^{j} can be continued if tendencies in either direction do not reach the end of S. The expanding will stop only if both ends of S have been reached, at which time i−j<0 and i+j>n-1. If fᵢ^{j} exceeds the left end of S, the backward tendency cᵢ₋ⱼ is represented by a terminator character ‘*’. If fᵢ^{j} exceeds the right end of S, the forward tendency cᵢ₊ⱼ is represented by a terminator character ‘$’. FIG. 1a is a table showing tendency feature for a root character cᵢ.

As the order increases, the length of tendency feature becomes longer. A fixed-length Tendency Key is proposed to represent an arbitrary-length tendency feature such that long tendency features can be compactly represented: Tendency Key=backward tendency+tendency order+forward tendency key.

Let fᵢ^{j} be a tendency feature of S. The fᵢ^{j} has start position i and order j. The tendency key of fᵢ^{j} is cᵢ₋ⱼjcᵢ₊ⱼ as shown in FIG. 1b.

FIGS. 1c and 1d are tables illustrate these concepts for a string S=“welcome”, including their start positions in S, the expanded tendency features and their origins. A tendency feature is a string. In addition to the starting position in S, each fᵢ^{j} has an Origin k which is the position of the root character with respect to the first character in fᵢ^{j}. Thus, a tendency feature can also be denoted as fᵢ^{j}(k) where k>0 and k≦|fᵢ^{j}|−2. For example, for the string S=“welcome”, f₃¹=Ico, which can be written also as f₃¹(1) because the position of the root character ‘c’ is in the second position with respect to the string ‘Ico’.

Each tendency feature fᵢ^{j}(k) represents a substring in S. Since fᵢ^{j}(k) is expanded in both the left and right directions with each increment in tendency order, a new string comparison mechanism is proposed to compare tendency features, which is called Tendency Left-Right Comparison or LR comparison for short. In order to perform string comparison in each order, an origin k has to be specified. Definition 1: In LR comparison, every string has an origin. The origin character has the highest priority, and then the priority order is backward tendency and forward tendency in turn in each following order.

The string comparison starts at the origin characters. After the origin characters are compared, the backward tendency and forward tendency are compared in turn and this process is repeatedly proceeded in the next tendency order until unequal tendency is found or either one of the strings can not be expanded. FIG. 1e is a table demonstrates few examples of the string LR comparison.

A tendency tree is an ordinary trie. The trie is a multi-way tree structure. Each node may have many child nodes. The number of the child nodes can be represented by a variable k, so each node in the tree is a k-ary (array) node. In a string S of length n, which consists of characters from a finite character set Σ of size |Σ|, a tendency tree, T_{α}, is a trie of all base tendency features in S with the same root character α. T_{α} is thus the tree of for all tendency features centered around α. Let δ be the number of unique root characters in {f₁¹, f₂¹, . . . , fₙ₋₂¹}. Then, there are δ tendency trees associated with string S and δ≦|Σ|.

In T_{α}, each tendency feature is stored as a fixed-length tendency key in a node. Each key has a starting position in S. Since the backward tendency can be |Σ| possible characters plus ‘*’ and the forward tendency can be |Σ| possible characters plus ‘$’, each node can have maximum (|Σ|+1)² child nodes. In T_{α}, because the sibling nodes share the same parent tendency feature, they can be ordered by tendency keys using LR comparison instead of being placed in Lexington graphic order. The Lexington graphic order is an order like the dictionary order. Note that the root of the tendency tree contains a special tendency key, “*1$”, which represents the starting point of the tree α.

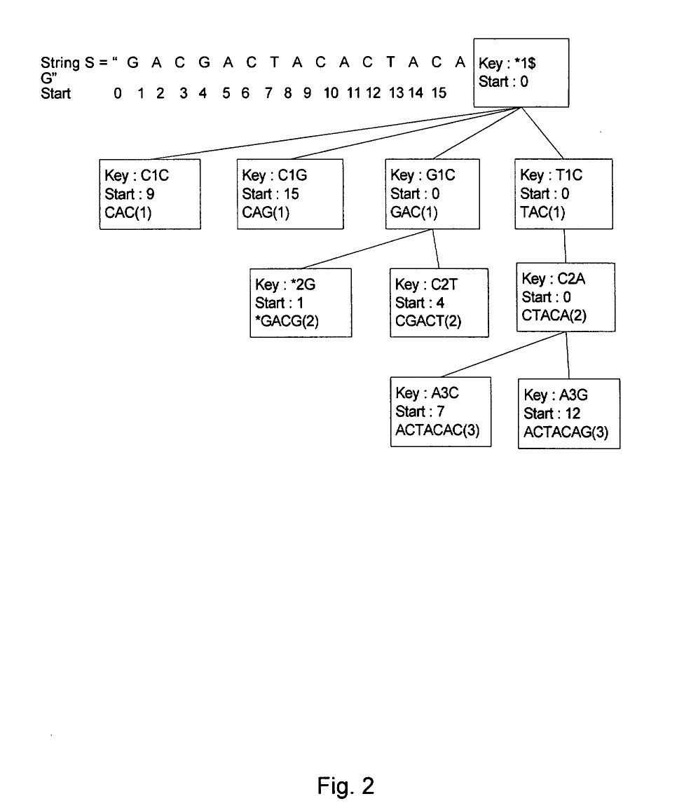

FIG. 2 shows a tendency tree, T_{A}, for the string S with root character ‘A’. Let L be a set containing all first order tendency features of S with the same root character ‘A’. In L, the tendency features are represented by tendency keys. Each key has a start position and is expressed as (key, start_position). L is the input data set of T_{A}. L={(G1C, 1), (G1C, 4), (T1C, 7), (C1C, 9), (T1C, 12), (C1G, 14)}. For example, for the tendency key C1C, the corresponding tendency feature is CAC and has start position at 9 in S. For a second order tendency key C2T, the corresponding tendency feature is CGACT and has start position at 4 in S. The parent node of C2T is G1C; note that it has start position of 0. This is because the tendency feature GAC appears multiple times in S. Any node with at least one child node is referred to as an internal node; any node with no child nodes is referred to as a leaf node.

Definition 2: In a tendency tree T_{α}, the ancestor nodes of k are all internal nodes in the path between the root and a given node with key k. For instance, in FIG. 2, the key A3G has ancestor nodes *1$, T1C and C2A. Definition 3: In a tendency tree, a tendency subtree starts at any given node and includes all its descendant nodes.

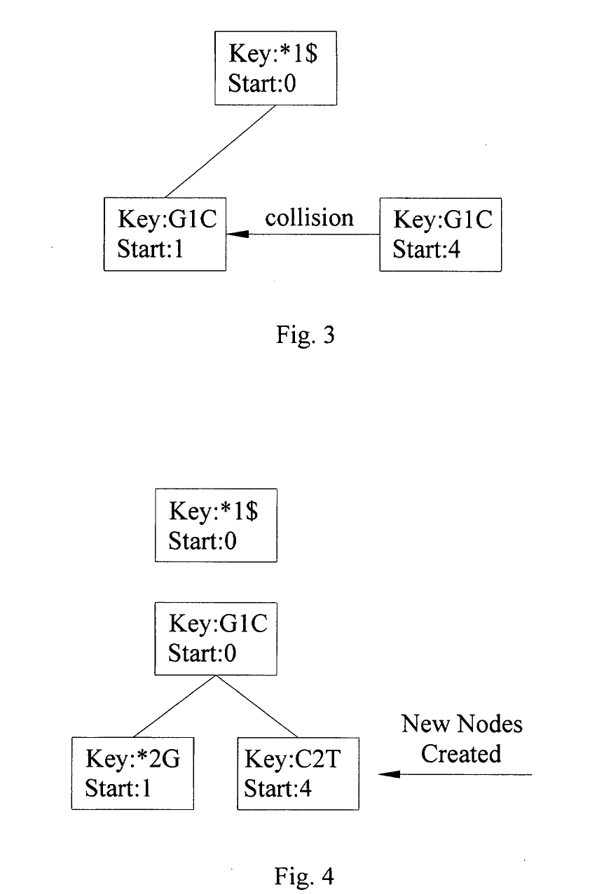

The height of a tendency tree grows whenever inserting a new key causes a collision. FIG. 3 shows an example of a collision. A collision means that under the same parent node, the insert key has the same backward and forward tendencies as the existing key in the tree. When a collision occurs, the tendency features for the insert key and the existing key needs to be retrieved from S and expanded to next order. The node which has existing key is referred to as the collision node.

In the collision resolution process, the expanded tendency features will be compared using the LR comparison. If they are different, two new child nodes are created under the collision node. The expanded keys and starting positions will be assigned to new nodes and a 0 will replace the start position in the collision node. If the expanded tendency features are still the same, the collision resolution is recursively applied, where both tendency features will be recursively expanded until a difference is found between the expanded tendency features. Tendency key collision can only happen in the leaf node.

FIG. 3 shows an example of a collision when (G1C, 4) is inserted into T_{A}. The represented tendency feature of (G1C, 1) and (G1C, 4) are retrieved from S and both are expanded to the next order. Since the difference can be identified between expanded tendency features, the collision resolution process terminates. In FIG. 3, two new keys, (*2G, 1) and (C2T, 4), are created and assigned to new child nodes. The node (G1C, 1) becomes a parent node and its start position is replaced by a 0. Any node with start position 0 is referred to as an empty node.

A collision also happens when (T1C, 7) and (T1C, 12) are encountered in FIG. 2. In this case, the collision is found not only at the first order but also detected at the second order. Finally, these two tendency keys are expanded to third order and become (A3C, 7), (A3G, 12).

The tendency tree is able to group similar tendency features together in a hierarchical manner. In a query string P of length w, where w≧3 (note that 3 is the length of a base tendency feature). P has a base tendency feature set, F={p₁¹, p₂¹, . . . , p_{w-2}¹}. Any tendency key pᵢ¹ with root character a can be used as a query key to search in the target string. The search will be conducted in a tree with root character α which is T_{α}. The search looks for the first order query key starting from the root node using LR comparison. If the key is found, the first order query key will be expanded and search continues to the next level and looks for the next order query key. The process goes on until a match is found, or if the key cannot be expanded, or if a leaf node is reached. The match can be either one of the following two cases:

1. The tendency feature represented by the key contains the entire query string and the matched node can be an internal node or a leaf node.

2. The matched node is a leaf node. The represented tendency feature is covered by the query string and is only a portion of the query string.

In case 1, the match node is a first matching point. The resulting subtree includes the match node and all its descendant nodes that have none-0 starting position. In case 2, the match does not guarantee that the entire query string is covered by the tendency feature represented by the tendency key. The string S has to be retrieved and examined from the position which is indicated by the key start position. If this match node is identified to cover the whole query string, this match node is the first match point.

Definition 4: During the tendency tree search, a first match point is a match node identified to cover the entire query string. This matched node is called the Target Node.

For example, assume the query string P=“TACA” is a substring of S in FIG. 2. P has two base tendency features TAC(1) and ACA(1). The numbers in the parentheses denote the origins of that string with respect to each tendency feature. Their respective tendency keys T1C and A1A can be used to search P in tendency tree T_{A} and T_{C}. Assume T1C is chosen to search P in T_{A}. A match can be found at the second order tendency key C2A, which represents “CTACA” and it covers the entire query string “TACA”, therefore (C2A, 0) is a target node. The result set of this search includes (A3C, 7) and (A3G, 12).

In another example, where the search string P=“GACTACAC” is a substring of S and has a set of base tendency features, F={GAC, ACT, CTA, TAC, ACA, CAC}. Any tendency feature in F can be used to search P in tree T_{α}. Again, if T_{A} is chosen to be searched, the represented keys with root character ‘A’ (i.e., G1C, T1C and C1C) can be used as the query keys.

The query of key T1C found the match node (A3C, 7) which represents the tendency feature “ACTACAC” starting at position 7 in S. Since “ACTACAC” is part of P, the string S needs to be retrieved and examined from position 7. After expanding the tendency feature from position 7, a match is found to cover P, therefore (A3C, 7) is the target node of this search. By using the same method, the query key G1C found the target node (C2T, 4) and the query key C1C found the target node (C1C, 6). Although three query keys obtain different target nodes, they represent the same search result, only with different starting positions in S.

In spite of the abilities discussed thus far for tendency trees, it may be impractical if the main memory is limited or the tendency tree is large. Since a tendency tree is an unbalanced tree, there is no I/O efficiency if the entire tree is stored in a secondary storage. To solve this problem, an approach is proposed to place the logical tendency tree into a B-tree like structure, stored in the secondary storage. This will allow us to achieve I/O efficiency and minimize the memory usage. Specifically, the structure of B+ trees is adopted as a physical layer to store the logical layer tendency tree.

As shown in FIG. 2, let L_{A} be a set of all tendency keys of T_{A}. The keys in L_{A} are retrieved and ordered by traversing the tree using the depth-first algorithm. The depth-first algorithm is used in traversing or searching a tree, tree structure or graph. The depth-first algorithm progresses by expanding the first child node of the search tree that appears and thus going deeper and deeper until a goal node is found. L_{A}={(*1$, 0), (C1C, 9), (C1G, 15), (G1C, 0), (*2G, 1), (C2T, 4), (T1C, 0), (C2A, 0), (A3C, 7), (A3G, 12)}.

As the description above, the tendency tree has demonstrated the capability of grouping similar tendency features together. After L_{A} was examined, L_{A} is found to inherit this capability from T_{A} and also is able to group similar tendency features together. For example, if the same query string P=“TACA” is searched in L_{A} using key T1C, the same target node (C2A, 0) and the same result set of (A3C, 7) and (A3G, 12) are found to be grouped together.

In B+ trees, a set of records sorted by key in Lexington graphic order is referred to as a sequence set and is stored in the leaf blocks. The largest key in each leaf block is promoted into an index block. An index block is referred to also as a separator block in the present invention. The set of indices in the index block is referred as an index set. A set of sorted tendency keys retrieved from the tendency tree using the depth-first algorithm is like a B+ tree sequence set and is called Tendency Sequence Set. This sequence set is placed in fixed-size leaf blocks. The smallest tendency key of each leaf block is promoted into an index block and is stored in a form of a tendency feature which plays a role as a separator. Similar to the B+ tree, the key promotion happens when a leaf block is full and needs to be split.

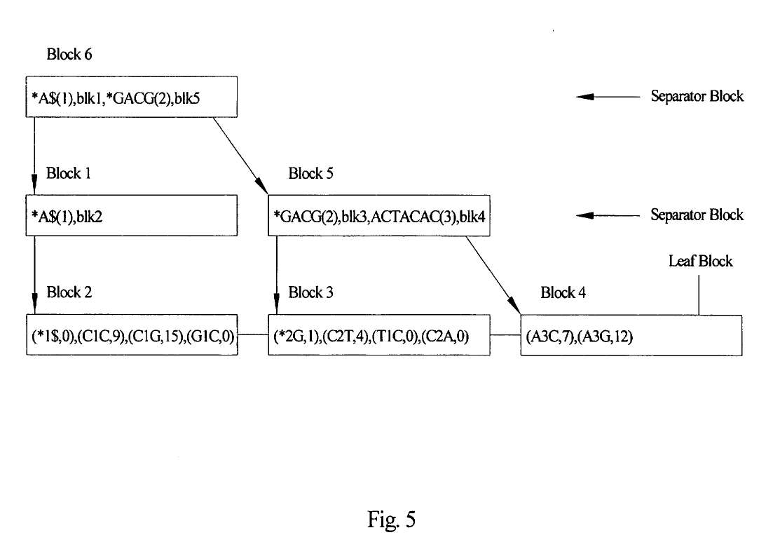

As mentioned earlier, each tendency feature fᵢ^{j}(k) has a starting position i in S and an origin k in fᵢ^{j}. After the key is promoted and becomes a separator, the key starting position is converted to a separator origin. This design offers an ability to perform LR comparison between separators and a given query tendency feature. In FIG. 5, each leaf block has a size of four which can accommodate four tendency keys. FIG. 5 shows an ideal situation. In reality, since split would only happen when block is full, most blocks won't be 100% full.

To find a given tendency feature in a tendency B tree, the search starts at the root separator block. Since each separator string has an origin, it is unique. Thus, binary search can be applied in the separator block using LR comparison. In addition to the origin, each separator also has a RBN (Relative Block Number). The RBN is a pointer to the corresponding leaf block. A separator is a starting point of the tendency sequence set in the leaf block. Each leaf block contains a tendency sequence set which is a segment of given tendency tree. A next block pointer is assigned to each leaf block. The entire tendency keys of given tendency tree T_{α} can be retrieved from the corresponding leaf blocks that are connected by next block pointers.

In a tendency B tree, the algorithm to find the correct leaf block is the same as the algorithm in B+ tree except that the LR comparison is used to compare the separator and query string. Nevertheless, the challenge is to traverse sequence set and find the target node in the leaf block.

Each leaf block contains a tendency sequence set and it represents a portion of the logical tendency tree. Recall that the tendency sequence set is obtained by the depth-first traversal of the tree. The difficulties of traversing leaf blocks are that there is no explicit label to indicate if this node is an internal node or a leaf node. Also, there is no explicit indication on how many child nodes are under the current node and whether the bottom of the tree has been reached. Finally, the same keys may be found under different parent nodes. For example, suppose there are two nodes with the same key B3C. One is under node A2B and another one is under node A2C. Although both nodes have the same key B3C, they are representing two different tendency features.

Each tendency key represents a tendency feature in a tendency sequence set also represents a domain. A domain of tendency features based on the same root character can be constructed as the set of all the tendency features of all possible orders.

Definition 5: Let L_{α} be a set of tendency keys of a root character α. The keys in L_{α} represent tendency features which are retrieved from String S and are sorted in Tendency Domain Order if:
1. The keys which are derived from the same parent key are ordered by LR comparison, and
2. For a given key, the keys of its child keys are placed before the keys of its right sibling keys.

A tendency sequence set in a leaf block has the ability to group related keys together as long as the tendency keys are sorted in their tendency domain order. The tendency features can be organized for a given string. In order to traverse the tendency sequence set and perform a search, the parent node, the child nodes, and the leaf nodes are needed to identify where the subtree ends.

Lemma 1: In a tendency sequence set L_{α} which is sorted in tendency domain order, a subtree starting at a given tendency key kᵢ with order oᵢ will terminate when a key kₓ with order oₓ is found where oᵢ≦oₓ. Let L_{α} be a tendency sequence set and kᵢ is a given tendency key in L_{α} where Lα={k₁, k₂, . . . , kₘ}. The variable i is the position of kᵢ in L_{α}, i≧1 and i≦m. The order of any given kᵢ is oᵢ. According to the Definition 5, L_{α} will have following properties:
1. If oᵢ=oᵢ+1, kᵢ and kᵢ+1 are expanded from the same parent node and representing sibling nodes. kᵢ doesn't have child node and is a leaf node.
2. If oᵢ<oᵢ+1, kᵢ+1 is expanded from kᵢ and kᵢ represents a parent node of kᵢ+1.
3. If oᵢ>oᵢ+1, kᵢ doesn't have child node and is a leaf node.

From the above properties, all descendents of kᵢ will have tendency orders greater than oᵢ, which means that the subtree of kᵢ ends whenever a key kₓ in the sequence set is encountered such that oᵢ≦oₓ.

According to description above, linear search can be conducted in leaf block to find the target node, with the separator as the search starting point. The relation between query string and separator may be used to skip unnecessary subtrees and improve search performance.
4. Definition 6: The Deepest Common Order (DCO) is the deepest order that can be reached by the match of both backward and forward tendencies in turn between two strings from their origins.

Let P(u) be a string with origin at position u and Q(v) be a string with origin at position v. The DCO of P(u) and Q(v) is expressed as DCO(P(u), Q(v)). If the origin characters are different for P(u) and Q(v), then DCO(P(u),Q(v))=−b 1. Otherwise, the two tendencies can be matched until order x, DCO(P(u), Q(v))=x−1.

Lemma 2: While searching in a tendency sequence set, LR comparison can start at a chosen key and skip unnecessary keys from the beginning of the sequence set. This chosen key is called the entry key. This entry key has order ≦DCO (query string, separator)+1. Let P(u) be a query string with origin u to be searched in a leaf block pointed by a separator Q(v) with origin v and DCO(P(u), Q(v))=x. This leaf block contains a tendency sequence set L_{α}. Let kᵢ be a given tendency key in L_{α} at position i with order of oᵢ. Since the separator Q(v) was promoted from the first key in the leaf block, the first key in L_{α} represents Q(v). If the first key in L_{α} has order y, it is x≦y.

If x<0, P(u) and Q(v) don't have common root character.

If x=0, P(u) and Q(v) don't have a tendency match in the first order. According to description above, if P(u) can be found in L_{α} the subtree of P(u) will start after the subtree of Q(v) ends. This means that P(u) must have a first order key kᵢ in L_{α} and oᵢ=1. Therefore, this entry key has order ≦DCO (query string, separator)+1.

If x>0, P(u) and Q(v) have tendency matches before order x+1. If P(u) can be found in L_{α}, P(u) must have a key kᵢ of order oᵢ, where oᵢ≦x+1. It is possible that P(u) has sibling node with order ≦x+1 prior to it. However, it is safe to start search at an entry key which has order <DCO (query string, separator)+1.

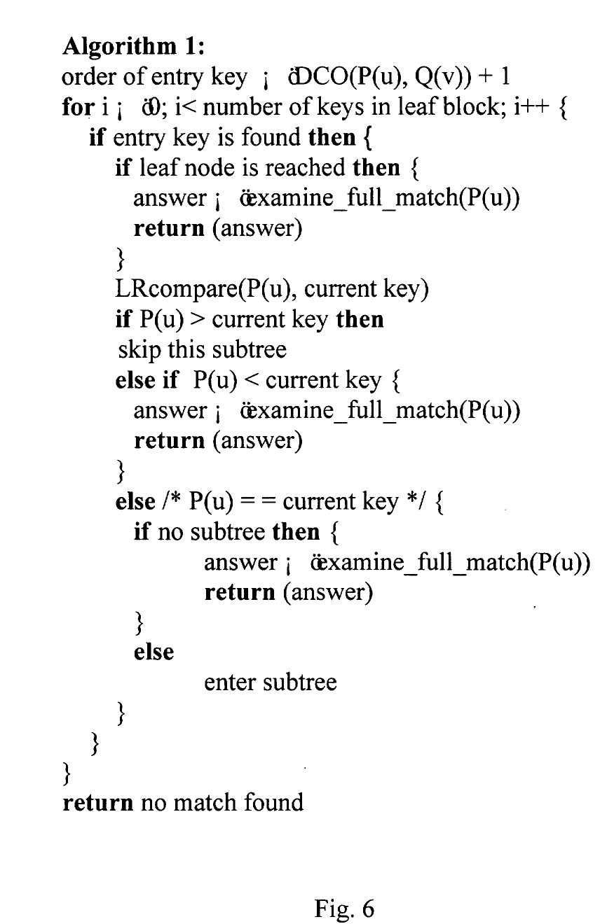

The previous description provides foundational theories to traverse the one-dimensional tendency sequence set in the leaf block. FIG. 6 is an algorithm proposed to find the target node for a given query string in a leaf block.

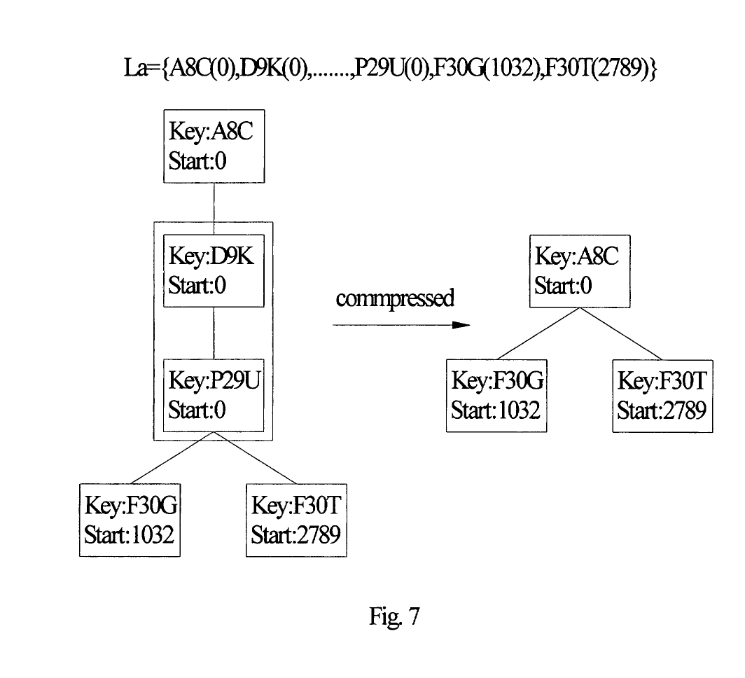

In DNA sequence search, each tendency key has a one-byte backward tendency, a one-byte forward tendency, a two-byte key order and a four-byte start position. Thus, one key will consume eight bytes (four bytes for key+four bytes for start position). Each leaf block has a two-byte count and a four-byte next-block pointer. Let B be the leaf block size. The maximum number of keys that can be stored in leaf block is thus (B−6)/8. In the worse case, the search needs to compare (B−6)/8*4≈B/2 bytes because each key has 4 bytes. The performance complexity as shown in FIG. 7 is O(B/2) plus p/B disk accesses, where p is the query string length. The p/B disk accesses are due to the match that may need to be examined by retrieving the string S.

The input data set of constructing a tendency sequence set is the same as constructing a tendency tree. It is a set of keys which represents all tendency features with the same root character from a given string. As the description above, when inserting a new key, if collision is detected, the collision resolution process could be repeated until the difference can be made between tendency features. If DCO of two collision keys is high, a lot of internal nodes would be generated. Each such internal node has a key with start position 0. It wastes space and impacts the search performance. In addition, it also creates a high probability that a long separator is selected when the leaf block is full and needs to be split.

A separator is stored in the form of tendency feature and is obtained directly from the promoted tendency key in the leaf block. If the order of the promotion key is high, the corresponding tendency feature will be very long. It may not be problematic in dictionary search because the string lengths are limited. However, it is not acceptable in many other applications. The DNA sequence search is an extreme case of string search. One string which is the DNA sequence could easily exceed 64 MB (mega bytes) long. In this kind of applications, key collision and keys with high tendency orders can happen frequently. Consequently, many long separators may be generated. Many long separators imply fewer separators can be accommodated in a separator block, leading to an increased number of disk accesses to reach leaf block since the height of the tree is increased. Furthermore, if the tendency order is too high, the separator length may be longer than the size of separator block itself. In order to overcome these issues, a compressed tendency sequence set is proposed and discussed next.

Let L_{α}={k₁, k₂, . . . , kₘ} be a tendency sequence set of root character α. Keys in L_{α} are retrieved from string S and sorted by tendency domain order. Let kᵢ be a given tendency key in L_{α}. The variable i is the position of kᵢ in L_{α}, 1≦i≦m. The order of any kᵢ is oᵢ.

In the tendency sequence set L_{α} that derived from a portion of tendency tree T_{α}. Let kᵢ and kᵢ₊₁ be two keys which had a collision at k_{c}. A compressed sequence set is a sequence of tendency keys in which all empty common ancestor nodes of kᵢ and kᵢ₊₁ between k_{c} and kᵢ in T_{α} have been removed.

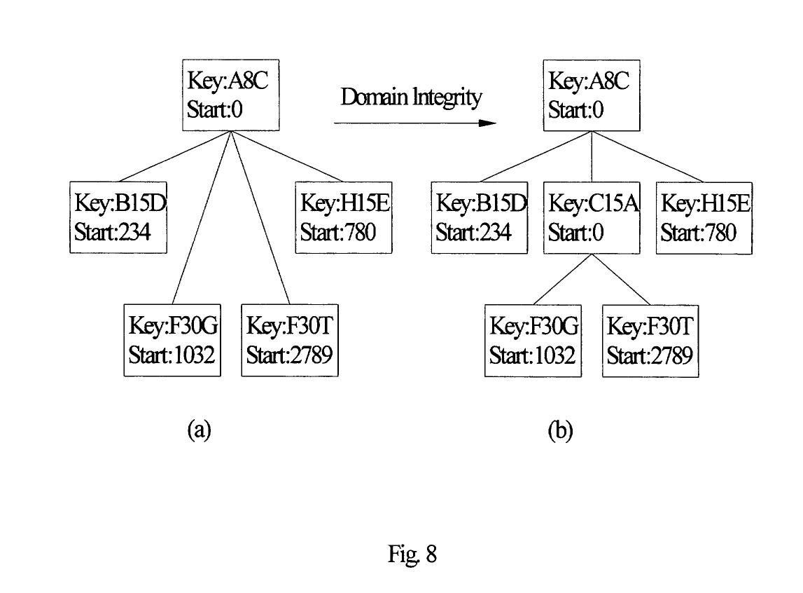

FIG. 7 shows two keys, F30G and F30T had collision at A8C. All empty ancestor nodes of F30G and F30T between key A8C and F30G can be removed because these nodes have start position 0. However, the keys in a compressed tendency sequence set may lose the tendency domain order property in some circumstances. FIG. 8a shows that under the same parent node, if there is any key whose order is less than the other of F30G, the keys in sequence set is no longer in the tendency domain order. For example, F30G and F30T will be placed next to each other in the sequence set, thus they appear to be child nodes of node B15D, but in fact they are not. To overcome this problem caused by compression, a domain integrity is introduced.

Definition 7: Let L_{α} be a compressed tendency sequence set of root character α. L_{α} has domain integrity if: A given key kᵢ with order oᵢ had collision at k_{c}. If there is a key kₑ with order oₑ which has the same ancestor node k_{c} and oₑ<oᵢ, kᵢ must have an ancestor node k_{d} with order o_{d} created between k_{c} and kᵢ where o_{d}=oₑ. FIG. 8b shows a compressed sequence set which maintains the domain integrity by adding an ancestor node C15A. Note that in an uncompressed sequence set, domain integrity is always preserved.

Theorem 1: Let L_{α} be a compressed tendency sequence set, where L_{α}={k1, k2 . . . , kₘ}. The variable i is the position of key kᵢ in L_{α}, 1≦i≦m. The tendency order of a given ki is oi. If Lα has domain integrity, Lemmas 1 and 2 can be applied on Lα as well.

Where kᵢ and kᵢ₊₁ had collision, any key kₑ between k_{c} and kᵢ with order oₑ<oᵢ must not be at the same tree level as kᵢ after compression. In other words, the key kᵢ must have an ancestor node placed prior to it with the same order oₑ. This constraint will guarantee that the all child nodes under the same parent node in the compressed sequence set can be correctly ordered by LR comparison. Thus, the compressed sequence set does not change the fact that child nodes are placed before the keys of its sibling nodes. This proves that a compressed sequence set satisfy Definition 5 and all keys obey the tendency domain order. It means that Lemma 1 can be applied on a compressed tendency sequence set if it has tendency domain integrity.

Let P(u) be a query string with origin u to be searched in a leaf block pointed by a separator Q(v) with origin v and DCO(P(u), Q(v))=x. This leaf block contains a compressed tendency sequence set L_{α}. Let kᵢ be a given tendency key in L_{α} at position i with order of oᵢ.

If x=0, P(u) and Q(v) don't have match in first order. Even if L_{α} is a compressed sequence set, P(u) must have a first order key kᵢ in L_{α}, where oᵢ=1 and that is oᵢ≦DCO(P(u), Q(v))+1.

If x>0, P(u) and Q(v) have matches before order x+1. Q(v) is represented by the first key in leaf block. Let the order of the first key in leaf block is y, thus y≧x. According to the definition of domain integrity, even if P(u) exists and has ancestor nodes removed in L_{α}, P(u) must have an ancestor node kᵢ with order oᵢ where oᵢ≦x+1 and that is oᵢ≦DCO(P(u), Q(v))+1. At this point, Lemma 2 is also applicable on compressed tendency sequence sets.

In a compressed tendency sequence set, a given key kᵢ had collision at k_{c}. All empty ancestor nodes of kᵢ between kᵢ and k_{c} have been removed by the compression process. If a tendency feature is embedded between kᵢ and k_{c}, the compressed sequence set will not be able to provide enough information to locate its correct position because of the missing ancestor nodes.

Since a tendency feature contains the backward and forward tendencies, one way to find the missing information between kᵢ and k_{c} is to retrieve the tendency feature of kᵢ from its original string S and then restore the missing ancestor node from the tendency feature. Let us consider a more complicated situation where not only kᵢ but also k_{c} had a collision at k_{b} and some ancestor nodes of k_{c} were removed between k_{c} and k_{b}. In this case, the tendency feature of kᵢ is still able to reveal the missing ancestor nodes between k_{c} and k_{b}.

Definition 8: In a compressed tendency sequence set, a key kᵣ can be used to reveal the missing ancestor nodes for a given query tendency feature f. The key kᵣ is called a revelation key of f.

Theorem 2: For any given query tendency feature f in a compressed tendency sequence set L_{α}, if L_{α} has domain integrity, there exist at least one revelation key of f. Revelation key may not be unique.

Let P(u) be a query string with origin u and Q(v) be a separator with origin v. If p^{t} is the query key of P(u) with order t to be searched in L_{α} and q+1 is the deepest order of p^{t} which can be expanded to. Thus, when p^{t} has order q+1, it has backward tendency of ‘*’ and forward tendency of ‘$’. Therefore, if P(u) can be found in L_{α}, p^{t} can be expanded to order q and it is that t=q.

According to theorem 1, an entry key kₓ can be found in L_{α}. Assume search was started at kₓ and stopped at k_{y}. The x and y are the key positions in L_{α}. R is a set which contains k_{y} and all keys of its ancestor nodes after kₓ in sequential order, R={a₁, a₂, . . . , aₘ}. Let any given key aᵢ in R has order oᵢ, i≧1 and i≦m. Search is stopped at aₘ, thus k_{y}=aₘ and has following possible situations:
1. Search stopped because of p^{t}<aₘ
   a. oₘ≦q
      It is that t≦q. The string P(u) is not fully covered by the tendency feature of p^{t} and is not existing in L_{α}.
   b. oₘ>q
      aₘ may have ancestor nodes removed and may cover string P(u). The tendency feature of aₘ needs to be retrieved from original string and examined.
2. Search stopped because of p^{t}=aₘ
   a. aₘ is an internal node and oₘ=q
      It is that t=q and aₘ may have ancestor nodes removed. aₘ may cover P(u) and needs to be examined.
   b. aₘ is a leaf node and oₘ<q.
      It is t<q. aₘ may have ancestor nodes removed. aₘ may cover P(u) and needs to be examined.

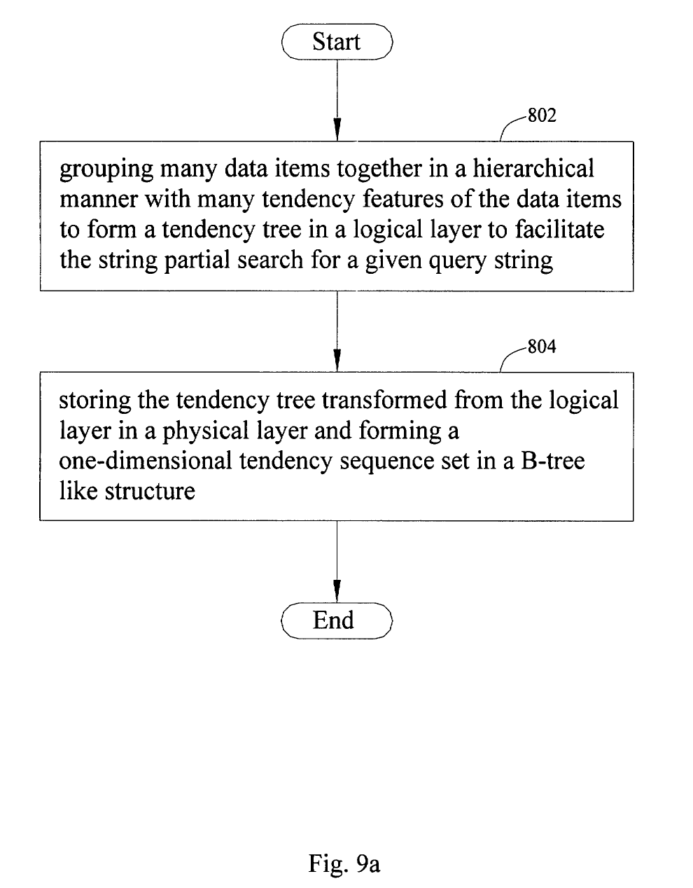

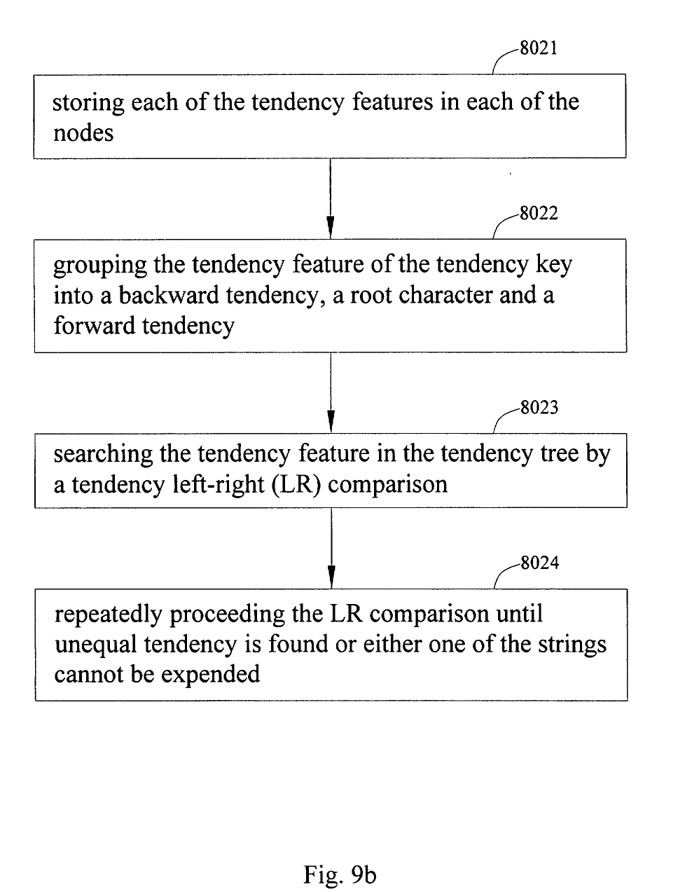

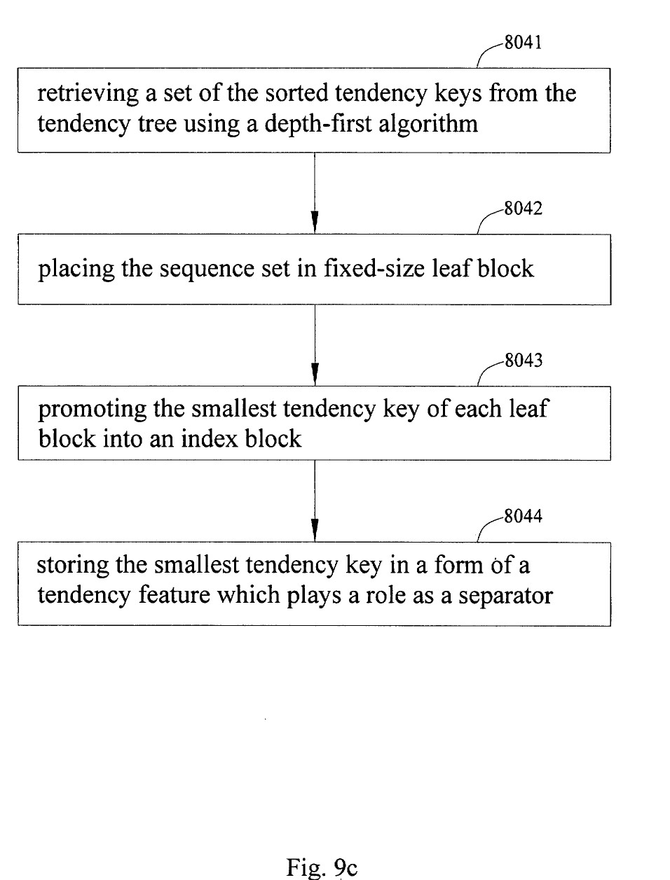

FIG. 9a is a flow chart showing the method for performing a string partial search. As shown in FIG. 9a, in step 802, it is grouping many data items together in a hierarchical manner with many tendency features of the data items to form a tendency tree in a logical layer to facilitate the string partial search for a given query string. The logical layer described here can be one or more memories in the computer. And in step 804, it is storing the tendency tree transformed from the logical layer in a physical layer and forming a one-dimensional tendency sequence set in a B-tree like structure. The physical layer described here can be one or more storage medias, such as hard drive, high capacity disk and so on. There are several nodes included in the tendency tree of the logical layer. And each of the nodes has a tendency key, which includes a fixed length and is used for representing an arbitrary-length tendency feature.

In the step 802, there are several steps included herein to do the string comparison in the physical layer. As shown in FIG. 9b, in step 8021, it is storing each of the tendency features in each of the nodes. In step 8022, it is grouping the tendency feature of the tendency key into a backward tendency, a root character and a forward tendency. The reason to group the tendency key is to facilitate the string partial search. The string comparison starts at the root characters. After the root characters are compared, the backward tendency and the forward tendency are compared in turn. In step 8023, it is searching the tendency feature in the tendency tree by a tendency left-right (LR) comparison. In step 8024, it is repeatedly proceeding the LR comparison until unequal tendency is found or either one of the strings cannot be expended. In order to perform the string comparison in each order, the position of the root character can also represent the start position in the tendency key and the start position is needed to specify.

In the step 802, the tendency key represents the tendency feature of the node and includes a start position and a tendency order representing an order of the node in the tendency tree. There are different types of nodes in the tendency tree. For example, the node with no child notes is a leaf node and the node with start position 0 is an empty node. The tendency tree is extendable, when a new tendency key is inserted and the height of the tendency tree is grown. If the new inserted tendency key has the same backward tendency and forward tendency as the existing tendency key in the tendency tree, a collision is occurred.

When in the step 8023, the LR comparison starts at an entry key and skips unnecessary keys from the beginning of the sequence set. The entry key can be any nodes in the first tendency order and the order of the entry key is less than the deepest order between the query string and the separator. The step 8024 is repeated until a target node is found and the target node can cover the entire query string. During the tendency tree search, a first match point is a match node identified to cover the entire query string. This matched node is called the target node.

In the step 804, it is further includes the following steps to do the string recovered in the string partial search and place the logical tendency tree into a B-tree like structure and stored in the secondary storage. As shown in FIG. 9c, in step 8041, it is retrieving a set of the sorted tendency keys from the tendency tree using a depth-first algorithm. In step 8042, it is placing the sequence set in fixed-size leaf block. In step 8043, it is promoting the smallest tendency key of each leaf block into an index block. In step 8044, it is storing the smallest tendency key in a form of a tendency feature which plays a role as a separator.

In step 8041, the keys in a set of all tendency keys are retrieved and ordered by traversing the tree using the depth-first algorithm. And the set of sorted tendency keys retrieved from the tendency tree using the depth-first algorithm is like a B+ tree sequence set and is called tendency sequence set. And the sequence set is placed in fixed size leaf blocks. The smallest tendency key of each leaf block is promoted into an index block and is stored in a form of a tendency feature which plays a role as a separator. An index block is referred to also as a separator block in the present invention. Therefore, the LR comparison is performed between separators and a given query tendency feature.

In step 8044, each tendency key represents a tendency feature in a tendency sequence set also represents a domain. A domain of tendency features based on the same root character can be constructed as the set of all the tendency features of all possible orders. In step 8044, it also identifies the deepest order reached by the match of both backward and forward tendencies in turn between two strings from their root characters and called a deepest common order (DCO).

In the worst case, all keys in R have ancestor nodes removed. It is that there is gap between any given as and aᵢ₊₁. In all of the above cases, aₘ can be a revelation key of p^{t}. The tendency feature of am can be used to fill in all missing ancestor nodes in the gap between any given aᵢ and aᵢ₊₁. Let d=DCO(p^{t}, aₘ). It indicates that tendencies of p^{t} have been matched with aₘ in each order from o₁ to order d. If p^{t} is a new insert key, the insert location will be between aᵢ and aᵢ₊₁ where d+1≦oᵢ and d+1<oᵢ₊₁. Since a revelation key and its sibling keys have the same ancestor nodes, the sibling keys of the revelation key can be a revelation as well. Therefore, a revelation key may not be unique.

Theorems 1 and 2 provide enough information to search an existing tendency feature in L_{α} and locate the insert location for a new key. In fact, Algorithm 1 can be used to search a given tendency feature in a compressed tendency sequence set. The only difference is the function of examine_full_match( ) in Algorithm 1. In an uncompressed sequence set, the order of an expanding key grows sequentially. There is no gap and missing ancestor nodes between parent node and child node. Therefore, the function of examine_full_match( ) only needs to retrieve original string to examine the match in one condition which is that the search stop at a leaf node because of p^{t}=aₘ and t<q. As opposed to the uncompressed sequence set, in a compressed sequence set, the function of examine_full_match( ) needs to retrieve the original string to examine the match in all cases except one condition which is that the search stops because of p^{t}<aₘ and oₘ≦q.

In the worst case scenario, the performance complexity of searching a compressed tendency sequence set is O(B/2)+O(p/B) disk accesses. This is the same as the complexity in Algorithm 1 for uncompressed tendency sequence sets. However, the space usage is improved significantly. Since one internal node can have many leaf nodes, the total number of internal nodes in the compressed sequence set is much less than the total number of leaf nodes and it guarantee that the space complexity is O(n) where n is the length of string S.

When inserting a new tendency feature f, Algorithm 1 can be used to find a revelation key kr. However, in the insertion process, the compared keys and their positions in the leaf block need to be referenced for later use to identify the insert position. In our implementation, an R array (Revelation Array) is used as an index array to reference this information in the leaf block. To achieve this, few changes are added into Algorithm 1 right after the LRcompare( ) function. In particular, R array contains the references of the ancestor nodes of the revelation key and its left sibling nodes.

The insert tendency feature P and revelation key kᵣ have common order of d=DCO(P(origin), kᵣ). The insert position should be right before the key whose order is ≧d+1 in R array. Assume oᵢ is the order of given key at position R[i] in the leaf block:
If oᵢ>d+1, R[i] is the insert position.
If oᵢ=d+1, R[i] is the insert position and collision is detected.

After the insert position is found, a new key of P with order of d+1 can be generated. If collision is detected, two new keys need to be created. Note that domain integrity needs to be maintained when inserting new keys. According to domain integrity in Definition 7 , all cases can be generalized to following two examples, assume kᵢ=B8C, kᵢ₊₁=B8D and they had collision at k_{c}=A2B:
A new insert key E5G has the same collision node at A2B and is greater than B8D. The insert position of E5G is right after B8D. The key order is: A2B, B8C, B8D, E5G.

In this case, sequence set will lose the domain integrity. Based on Lemma 1, key A2B is terminated at B8D and is not considered to be the parent node of E5G. In order to maintain the domain integrity, an ancestor node of B8C needs to be inserted between A2B and B8D. This ancestor node will have order of 5. Assume this ancestor node has a key E5F. The key order become: A2B, E5F, B8C, B8D, E5G. After E5F is inserted, E5G can be identified as the sibling node of E5F and is a child node of A2B.
A new insert key E5D has the same collision node at A2B and is less than B8D.

The insert position of E5D is right before B8C. The key order is: A2B, E5D, B8C, B8D.

In this case, sequence set will lose the domain integrity. Based on Lemma 1, domain B8D is considered to be a child node of E5D but in fact it is not. In order to maintain the domain integrity, an ancestor node of B8C needs to be inserted between A2B and B8C. This ancestor node will have order of 5. Assume this ancestor node has a key E5F. The key order become: A2B, E5D, E5F, B8C, B8D. After E5F is inserted, B8C can be identified as the child node of E5F instead of E5D. The summaries of the strategies in our implementation are as following:
1. Find revelation key using Algorithm 1.
2. During the search, store references of all compared keys in an R array.
3. Obtain DCO(P(origin), kr).
4. Identify the insert position using the DCO(P(origin), kr) and R array.

### Insert necessary keys and maintain the domain integrity.

In tendency B tree, the process of splitting leaf block and separator block is similar to B+ tree. The thing needs to be aware is that since separator represents the first key of the leaf block and is always the smallest key in the leaf block, there is no need to update separator when key promotion happens. As mentioned in section 4.5, the length of the separator can be an issue. Fortunately the compressed tendency sequence set provides us a path to walk around this obstacle. Separator is generated when leaf block is split and the order of the promotion key will decide the length of the separator. One way to avoid the long separator is to do a neighborhood search when choosing the promotion key.

In an uncompressed sequence set, the benefit of neighborhood search is very limited because for a given key, the tendency orders of its neighbors are very close. If the key in the middle of leaf block has a high order, there is very high possibility that the tendency orders of it neighbors are high as well. In contrast to that, since the keys are compressed in a compressed sequence set, there are good chances to find a lower order key around any given key in the leaf block.

The neighborhood search in compressed tendency sequence set is simple because search only needs to compare the key order starting at a middle key of the leaf block and proceed in its left and right directions.

In our implementation, a search range and a max acceptable order are defined. The negative impact of choosing a promotion key using neighborhood search is that a tree can be a little unbalance because some separator blocks may contain more separators. However, experiment results show that overall performance impact caused by this tradeoff is very little.

In one embodiment, the tendency B trees were implemented for the DNA sequence as well as for a 175, 171-entry English dictionary. In order to observer the scalability of tendency B trees, multiple setups were experimented. Tendency B trees have been constructed for 10 Mbp, 20 Mbp, 30 Mbp, 40 Mbp, 50 Mbp, 60 Mbp and 70 Mbp DNAs which are extracted from a fruit fly sequence with alphabet size of 4. In the dictionary search, tendency B trees are shared and constructed for 175, 171 short strings which are all unique dictionary words. In the dictionary case, every word has word ID to replace tendency feature starting position. In order to perform the tendency feature comparison during the collision resolution process, an extra byte is added to tendency key to represent the origin of the dictionary feature.

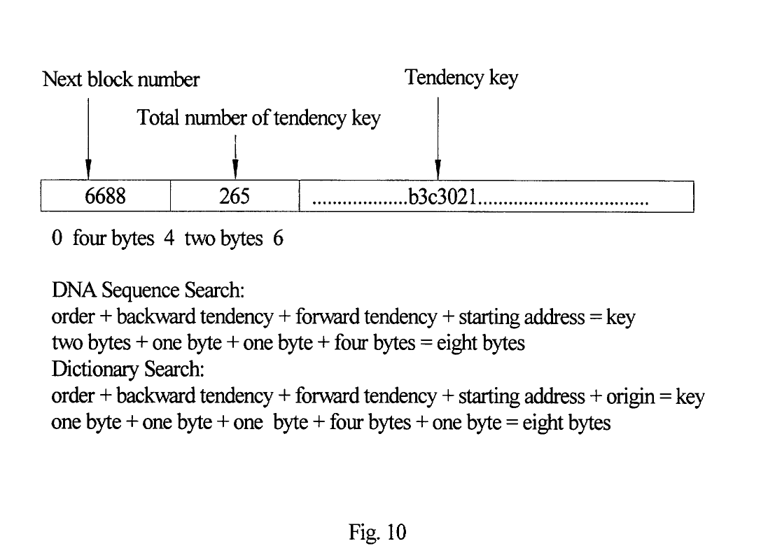

In both DNA and dictionary searches, the design of the separator block is similar to B+ trees. The differences are that there is a two-byte origin attached with the separator in the DNA sequence search and a one-byte origin in the dictionary search. The format of leaf blocks and tendency keys are shown in FIG. 10. Both leaf and separator blocks have the same block size of 8 k in the DNA search and 4 k in the dictionary search.

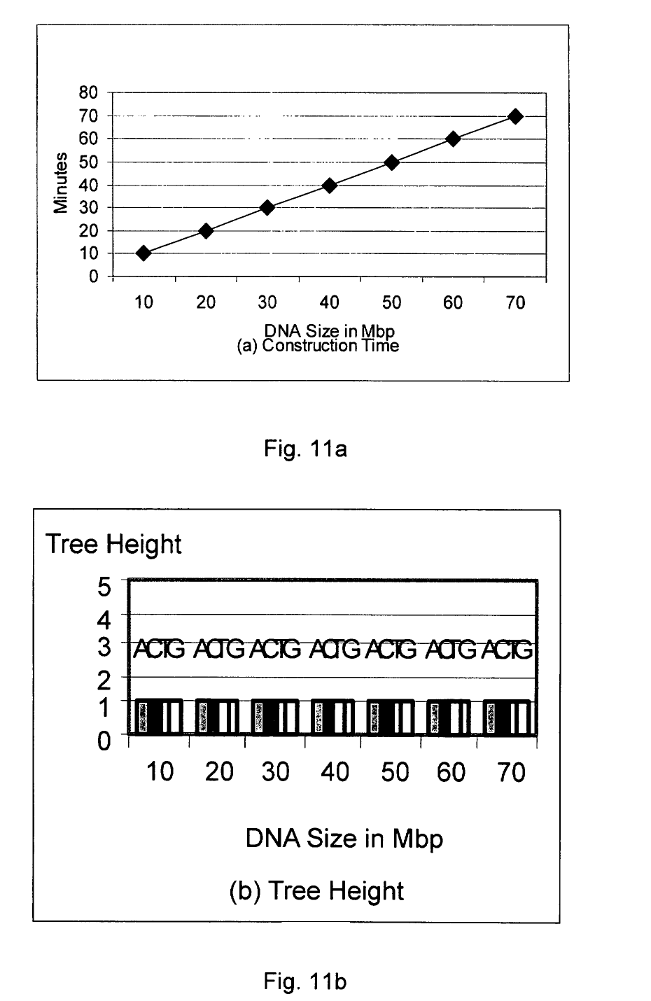

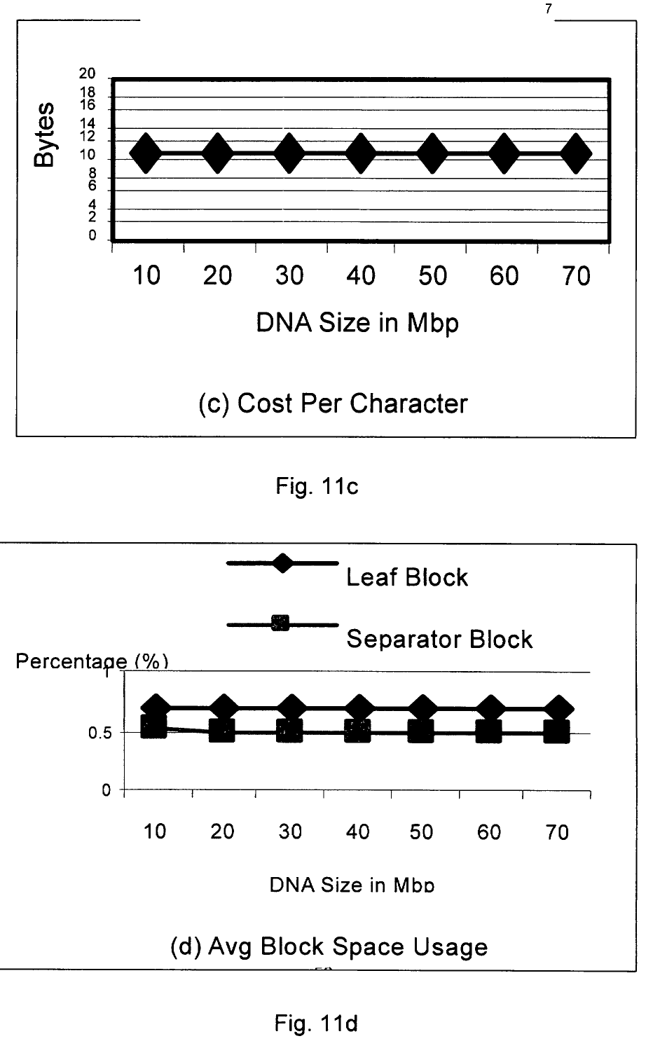

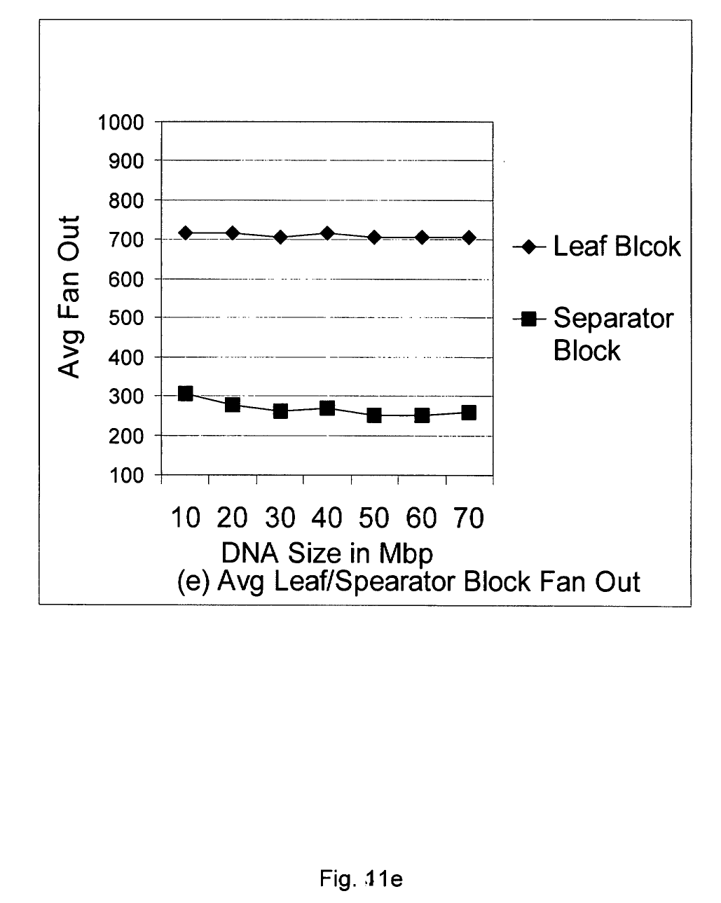

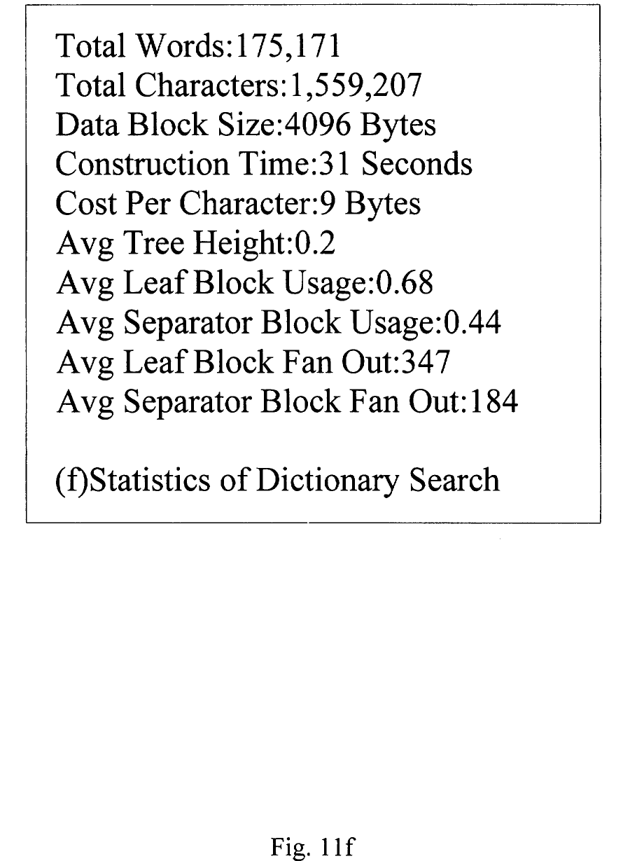

In the implementations, the terminator of backward tendency ‘*’ is replaced by ASCII character 02 (STX). The terminator of forward tendency ‘$’ is replaced by ASCII character 03 (ETX). The experiment is conducted on a 2.26 GHz Pentium 4 PC, with 1.5 GB RAM and one 7200 RPM IDE disk drive. The program was developed on Windows XP using C++ 5.0. All tendency B trees are constructed in-memory and stored in data files after the construction completes. FIG. 11a-FIG. 11f show the experimental results. In FIG. 11b, the tree height is the number of levels between the root and a leaf block. Since the root is always in the main memory, to access a leaf block will take height+1 disk I/O.

Base on FIG. 11b and FIG. 11f, the average heights of the trees on both DNA search and dictionary search are ≦1. This result indicates that the first matching point of any given string can be reached in (height+1+p/B)≈(2+p/B) disk I/O. This search efficiency is stable and superior to existing methods. The data sets of DNA sequence have a smaller alphabet size but uniform letter distribution. The small alphabet creates a higher probability for duplicate patterns. On the other hand, the even character distribution provides neighborhood search good chances to find a proper length separator. On the other hand,

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A structure for string partial search comprising:
a logical layer including a tendency tree used to group a plurality of data items together in a hierarchical manner to facilitate the string partial search for a given query string; and
a physical layer storing a tendency sequence set transformed from the tendency tree.

2. The structure of claim 1, wherein the tendency tree includes a plurality of nodes, and each of the nodes comprises:
a tendency key having a fixed length, for representing an arbitrary-length tendency feature.

3. The structure of claim 2, wherein the tendency key is grouped into:
a tendency order for defining a currently compared length of the arbitrary-length tendency feature;
a backward tendency for representing a previous character in term of the currently compared length; and
a forward tendency key for representing a latter character in term of the currently compared length.

4. The structure of claim 3, wherein the given query string comprises a root character as a starting position for the string partial search, and the backward tendency and the forward tendency continue to be compared if the arbitrary-length tendency feature has a character identical to the root character.

5. The structure of claim 3, wherein if an insert key has the same backward and forward tendencies as an existing key in the tendency tree, the tendency features for the insert key and the existing key are expanded to a next order for further comparison.

6. The structure of claim 2, wherein the tendency key is retrieved from the tendency tree by using a depth-first algorithm and placed into a B-tree-like structure.

7. The structure of claim 6, wherein a largest key and a smallest tendency key in a leaf block of the B-tree-like structure are promoted into index blocks as separators when the leaf block is full, and the separators are a starting point of the tendency sequence set in the leaf block.

8. The structure of claim 7, wherein each of the separators has a RBN (Relative Block Number) as a pointer to the corresponding leaf block.

9. A method for performing a string partial search comprising:
grouping a plurality of data items together in a hierarchical manner with a plurality of arbitrary-length tendency features of the data items to form a tendency tree in a logical layer to facilitate the string partial search for a given query string;
transforming the tendency tree into a one-dimensional tendency sequence set; and
storing the one-dimensional tendency sequence set in a B-tree like structure.

10. The method of claim 9, wherein the tendency tree comprises a plurality of nodes and the group step comprises:
assigning each of the data items to an appropriate node of the nodes; and
assigning a tendency key to each of the nodes, the tendency key has a fixed length to represent the tendency feature.

11. The method of claim 9, wherein the group step comprises:
grouping the tendency feature into a tendency order, a backward tendency and a forward tendency key; and
searching the tendency feature in the tendency tree by a tendency left-right (LR) comparison;
wherein the searching step is repeated until an unequal tendency is found or either one of the strings cannot be expended.

12. The method of claim 10, wherein the step of assigning a tendency key comprises:
assigning the node having at least one child node as an internal node; and
assigning the node having no child note as a leaf node; and
assigning the node having a start position as an empty node.

13. The method of claim 11, wherein the step of assigning a tendency key comprises
determining whether a new tendency key is inserted; and
if yes, extending the tendency tree.

14. The structure of claim 11, wherein the given query string comprises a root character and the searching step comprises:
assigning the root character as a starting position for the string partial search;
determining whether the tendency feature has a character identical to the root character;
if yes, comparing the backward tendency and the forward tendency.

15. The method of claim 9 further comprising:
retrieving a set of the tendency keys from the tendency tree by using a depth-first algorithm;
placing the sequence set in a fixed-size leaf block;
promoting a smallest tendency key of each leaf block into an index block; and
storing the smallest tendency key in a form of a tendency feature which plays a role as a separator.

16. The method of claim 15, wherein the retrieving step comprises:
utilizing the tendency key to reveal missing ancestor nodes for the given tendency feature.

17. The method of claim 15, wherein the retrieving step comprises:
removing all empty common ancestor nodes.

18. The method of claim 15, wherein the separator is a starting point of the tendency sequence set in the leaf block.

19. The method of claim 14, wherein the storing step constructs a domain of the tendency feature based on the same root characters.
